(19) United States
(12) Patent Application Publication
(10) Pub. No.: US 2008/0163854 A1
(43) Pub. Date: Jul. 10, 2008

(54) Fully automatic fuel system for diesel engines operated with diesel and vegetable oil

(76) Inventor: Peter Josef Karner, Glastonbury, CT (US)

Correspondence Address: PETER KARNER, 252 SUNSET DR., GLASTONBURY, CT, 06033, US

(21) Appl. No.: 11/651,114

(22) Filed: Jan. 6, 2007

(51) Int. Cl. F02B 1/00

(52) U.S. Cl. 123/543

(57) ABSTRACT

Vegetable oil fuel system for diesel engines consisting of a diesel and vegetable oil system. When started cold, the engine 20 is supplied with diesel and when the engine reaches a certain temperature, which depends on the engine design, at this point the fuel supply will switch to vegetable oil. During normal operating conditions, the engine 20 runs on vegetable oil, which is heated by a heat exchanger 16 which is supplied by engine cooling water. In addition, the vegetable oil will be electrically heated when passing through the filter 15 during cold start conditions.

### REFERENCE IS MADE TO

DE 20 2004 020 597 U1
DE 101 31 630 A1
DE 38 00 585 A1
DE 10 2005 052 086 A1

### FIELD OF INVENTION

The invention relates to improvements concerning a fuel system for diesel operated engines running on vegetable oil during normal operating conditions. The fuel system consists of both a diesel fuel circuit and a vegetable oil circuit. The fuel system is operated with diesel fuel during the cold start phase and with pure vegetable oil under normal operating conditions. In addition, the fuel system is fully microprocessor controlled and is basically designed for the use of recycled vegetable fryer oil and alternatively for winter conditions. The invention is suitable to all types of diesel engines.

### BACKGROUND OF THE INVENTION

Diesel engines operated with vegetable oil under normal operating conditions are known from prior art document DE2020004020597U1, which discloses diesel engine supplied with diesel or vegetable oil from two different tanks. The fuel can be supplied alternatively from a single tank or from both tanks simultaneously.

It is the subject of the present invention to disclose a way to best implement the fuel system according to DE2020004020597U1 and to disclose a way to easily adapt the conventional fuel system of a diesel engine to a diesel engine running with diesel and vegetable oil.

### SUMMARY OF THE INVENTION

The object of the present invention is to provide a diesel engine with a fuel system which operates on vegetable oil during normal operating conditions of the engine. Used vegetable oil applied as fuel for diesel engines is currently becoming more and more attractive for economic and environmental reasons.

The actual price per gallon of recycled vegetable oil is about 70% less than for diesel fuel. It is expected that the price difference between recycled vegetable oil and diesel could even increase in the future.

Moreover, vegetable oil is derived from a renewable resource of which there no shortage as in the case of diminishing fossil fuel supplies.

Furthermore, an engine which operates on vegetable oil instead of diesel fuel also shows some advantages concerning the emission of pollutants:

The carbon black concentration in the exhaust gas is reduced by approximately a third and there is no emission of sulfur compounds at all. The carbon dioxide emissions remain the same but there's still a closed circuit between the carbon dioxide consuming plants which vegetable oil is made of and the carbon dioxide producing diesel engine burning vegetable oil. Using this renewable source of energy will be one step in the prevention of global warming.

Due to reduced flammability of vegetable oil compared to diesel, the engine operated with vegetable oil runs more smoothly.

### BRIEF DESCRIPTION OF THE DRAWINGS

The present invention can be best understood through the following description and accompanying drawings, wherein:

FIG. 1 shows a schematic of the fuel system comprising the diesel and the vegetable oil system according to the invention,

FIG. 2 shows a schematic of the diesel fuel circuit,

FIG. 3 shows a schematic of the vegetable oil circuit,

FIG. 4 shows a schematic of the second embodiment of the fuel system and

FIG. 5 shows a schematic of an alternative hose heat exchanger for vegetable oil heating instead of the block heat exchanger.

FIG. 6 shows a schematic of an alternative hose heat exchanger in combination with a tank heating system powered by one water pump.

FIG. 7 shows a schematic of an alternative hose heat exchanger in combination with a tank heating system powered by two water pumps.

### DETAILED DESCRIPTION

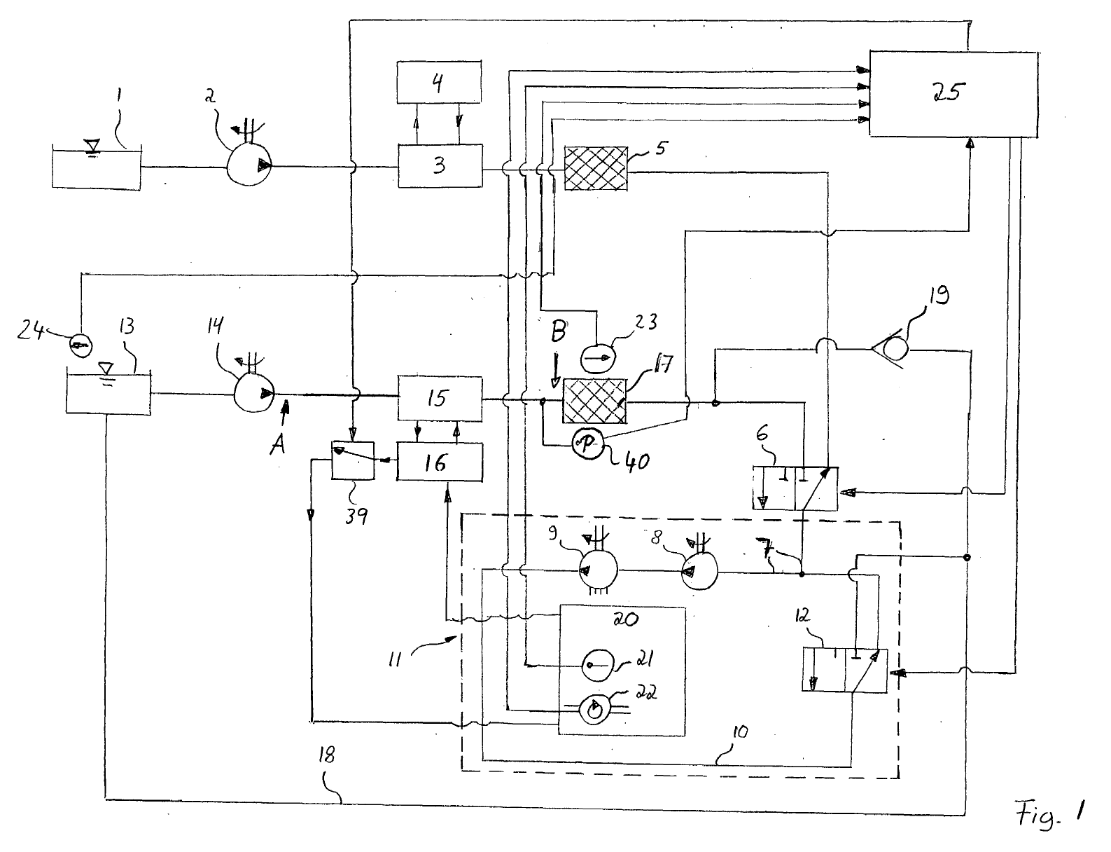

FIG. 1 shows the fuel system of the present invention. There are two separate fuel circuits for diesel and vegetable oil.

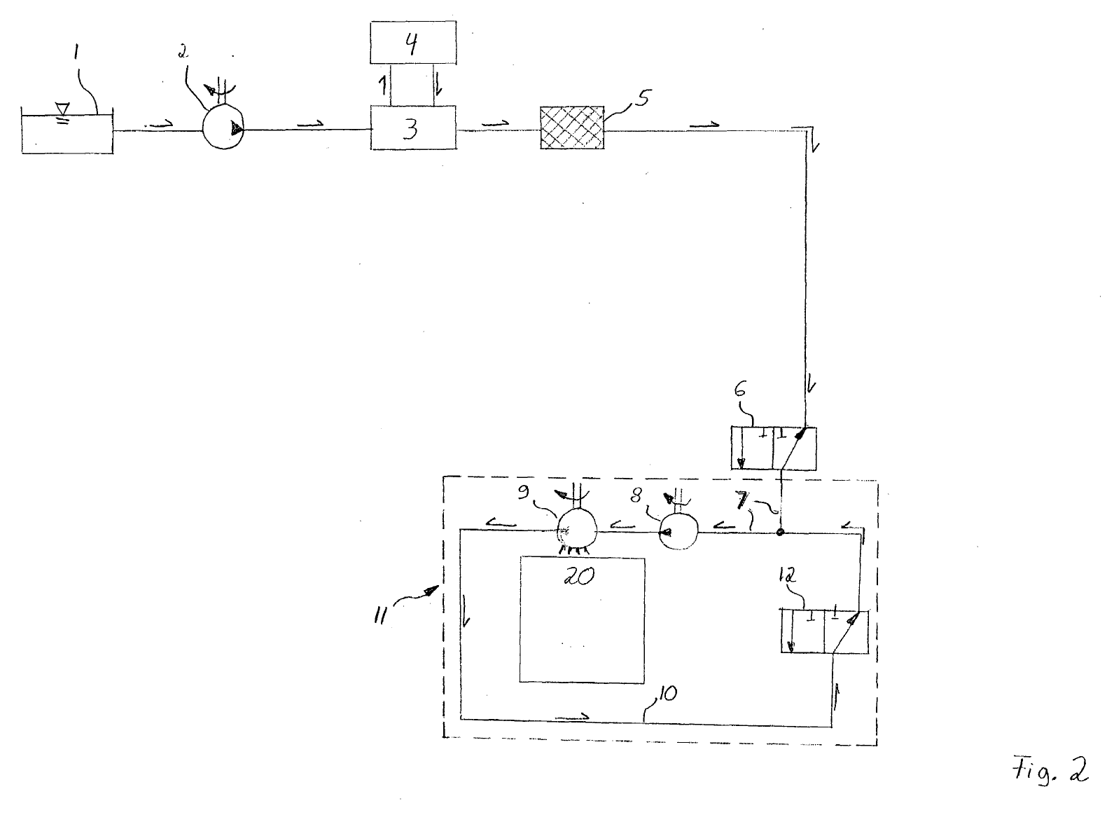

In greater detail, FIGS. 1 and 2 show a first circuit for diesel fuel consisting of the diesel tank 1, an electric diesel fuel pump 2, a mechanical fuel temperature controller 3 coupled to a heat exchanger 4 supplied by engine cooling water, a fuel filter 5 and a first 3/2-way solenoid valve 6. Diesel tank 1, fuel pump 2, temperature controller 3, fuel filter 5 and 3/2-way solenoid valve 6 are connected serially by fuel pipes. Furthermore, solenoid valve 6 is connected via pipe 7 to a circuit 11 consisting of the feed pump 8, the fuel injection pump 9, the pipe 10 and a second 3/2-way solenoid valve 12.

In contrast to vegetable oil, winter-diesel has a freezing point far below the freezing point of vegetable oil. Therefore, it is necessary to run the engine with diesel from cold start up to the point in time, when the engine reaches the suitable temperature for a complete combustion of the vegetable oil. As long as the temperatures of the injectors and combustion are too low for a proper vegetable oil injection and combustion, the solenoid valve 6 keeps the vegetable oil supply closed and the diesel fuel supply open. Thus, during cold start conditions of the engine, the diesel fuel is sucked by the feed pump 8 from the diesel tank 1, passes the controller 3 and the filter 5 and then flows to the circuit 11. The superfluous diesel which has not been consumed by the fuel injection pump 9 flows back to the solenoid valve 12, which is switched in such a way as to make the diesel circulate in circuit 11. The electric fuel pump 2 is only used for automatic ventilation of the diesel fuel circuit after repair or filter change.

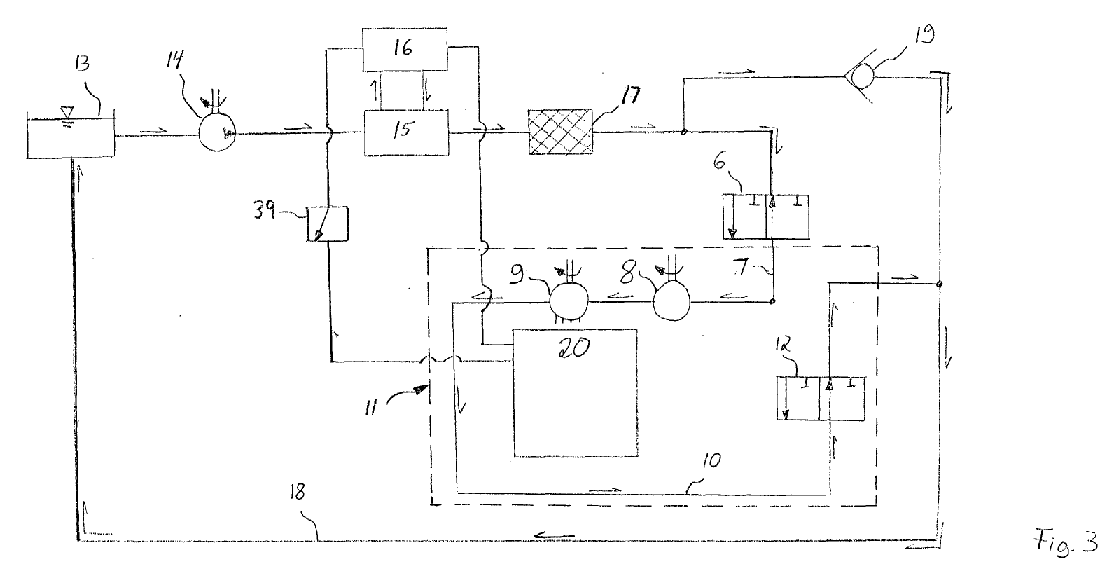

FIGS. 1 and 3 show a second fuel circuit consisting of the vegetable oil tank 13, an electric vegetable oil pump 14, a second mechanical fuel temperature controller 15 coupled to a block heat exchanger 16 and an electrically heated fuel filter 17, as well as the already mentioned solenoid valve 6, the pipe 7, the feed pump 8, the fuel injection pump 9, the pipe 10 and the solenoid valve 12. Moreover, there is a return pipe 18 which makes the connection between the vegetable oil tank 13 and the solenoid valve 12. As soon as the combustion temperature in the diesel engine has reached a suitable level for the combustion of vegetable oil and the temperature of the vegetable oil is high enough, the solenoid valve 6 stops the diesel fuel supply and switches to vegetable oil supply. The vegetable oil is then sucked by the pump 14 from the tank 13, passes the controller 15, the filter 17, the solenoid valve 6 and the feed pump 8 and is fed to the fuel injection pump 9. The vegetable oil not consumed by the fuel injection pump 9 returns via pipe 10 to solenoid valve 12 and is then sucked by the feed pump 8 again. A check valve 19 leads the superfluous fuel into the return pipe 18 and provides constant fuel pressure on solenoid valve 6 which prevents operating failures, especially under winter conditions.

The mechanical fuel temperature controller 15 maintains a regular vegetable oil fuel temperature of approximately 158° F. (70° C.) independent from the heat exchanger and temperature of incoming fuel. The controller 3 and heat exchanger 4 provide a regular diesel fuel temperature of approximately 75° F. (25° C.).

While adapting the conventional fuel system of the diesel engine to a diesel engine running with diesel and vegetable oil, the feed pump 8 and the fuel injection pump 9 remain as originally installed.

The system is controlled by a microprocessor 25 and thus, no handling errors can occur. The plant controls the engine, tank and filter temperature with the sensors 21, 23 and 24 and switches to vegetable oil supply when proper operating conditions are guaranteed. Then electric signals are sent from microprocessor to the solenoid valves 6 and 12. Also the diesel flush mode as well as the shut off of the engine and the ventilating of the plant are exceeded according to the programming.

During diesel operation the solenoid valves 6 and 12 do not receive any electrical signal what remains the engine operative even if operating errors force a shutdown of the controlling system. During diesel and vegetable oil operation the fuel circulates around the fuel injection pump 9 which has the following advantage:

Until the moment when the system switches to vegetable oil, the fuel circuit 11 is filled with diesel. At this moment, the diesel mixes with vegetable oil and the diesel concentration continuously diminishes. This enables a smooth change over to vegetable oil operation at low engine temperatures and this allows to switch to vegetable oil supply at lower engine temperatures, at approximately 75° F. (25° C.), depending on the engine design.

Solenoid valve 12 enables the flush mode of the circuit 11 for a quick engine shut off. The solenoid valve 6 switches to diesel while solenoid valve 12 keeps the return pipe open as long as the incoming diesel has displaced the remaining vegetable oil from the circuit 11. Before diesel reaches the vegetable oil return pipe 18, the solenoid valve 12 switches to circulation within the circuit 11. The correct switch over is guaranteed by the microprocessor 25, which receives a revolution signal from the contact-free revolution sensor 22 on the engine. Thus, after a few seconds the fuel injection pump 9 is mostly filled with pure diesel and after several seconds, according to engine type and revolutions, the pipes and injectors get fully filled with diesel, as well. The engine can now be shut off manually or automatically and afterwards an effective diesel cold start is possible. For short shut off periods before the engine cools down too much, the engine can be shut off without diesel flush. This is dependent on engine type and ambient air temperature and can be from a half hour to 5 hours. In this case, the controller 25 reads an input from the operator, determining whether he wants to shut off the engine for a short or a long period. Only then is an engine shut off possible, except in an emergency.

As long as the engine 20 runs, the vegetable oil pump 14 is activated and therefore vegetable oil is constantly pumped through the filter 17, especially after an engine cold start. Thus, a quick heating of the filter 17 is possible. After the switch over to vegetable oil, a constant fuel pressure is provided at solenoid valve 6 by check valve 19. Operating errors due to lack of fuel or due to a low pressure are therefore eliminated.

Also, for temperatures below 32° F. the fuel supply is improved as the mechanical low pressure fuel pump 9 is relieved. This prevents any danger of air being sucked into the system, which may be caused by low pressure due to excessive fuel viscosity. This danger can only be eliminated if the delivery rate provided by the electric vegetable oil pump 14 exceeds the required amount of fuel of the engine.

The vegetable oil pump 14 enables the ventilation of the whole vegetable oil system. For this purpose the solenoid valve 12 must be switched to vegetable oil return and the engine must not be started. After a fuel filter change or system repair the ventilation mode can be activated by the operator and the microprocessor controls this procedure automatically.

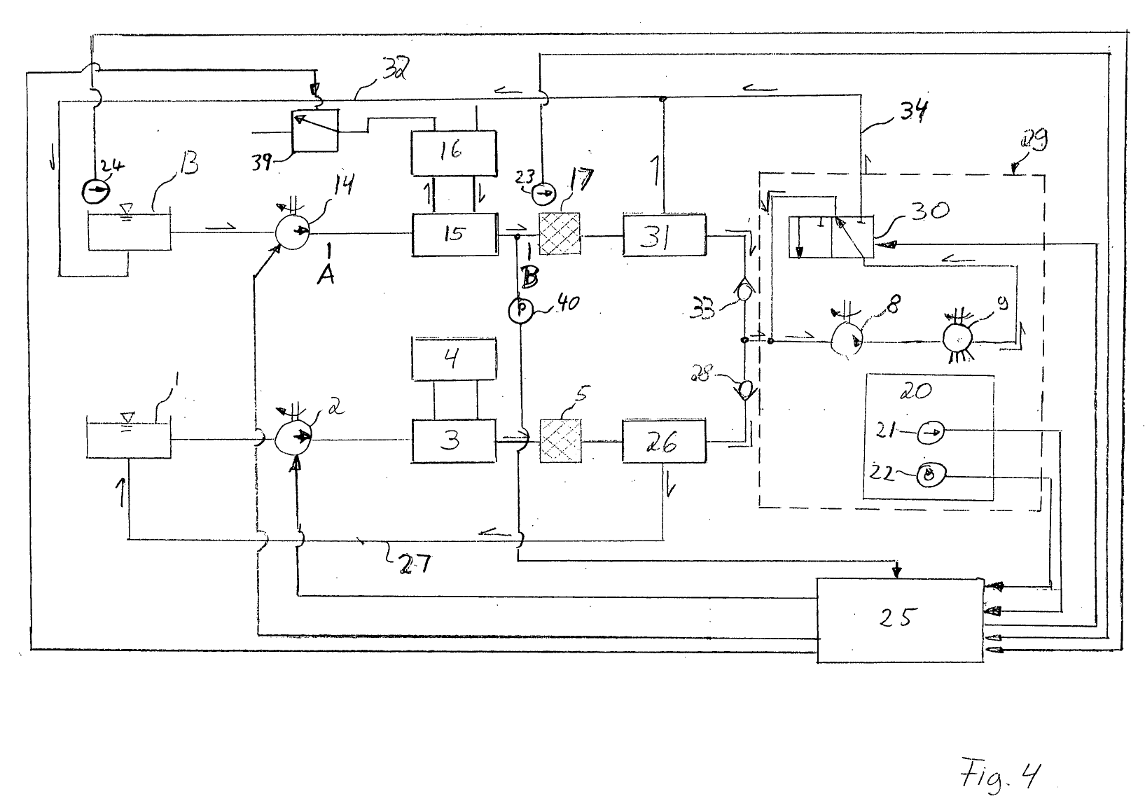

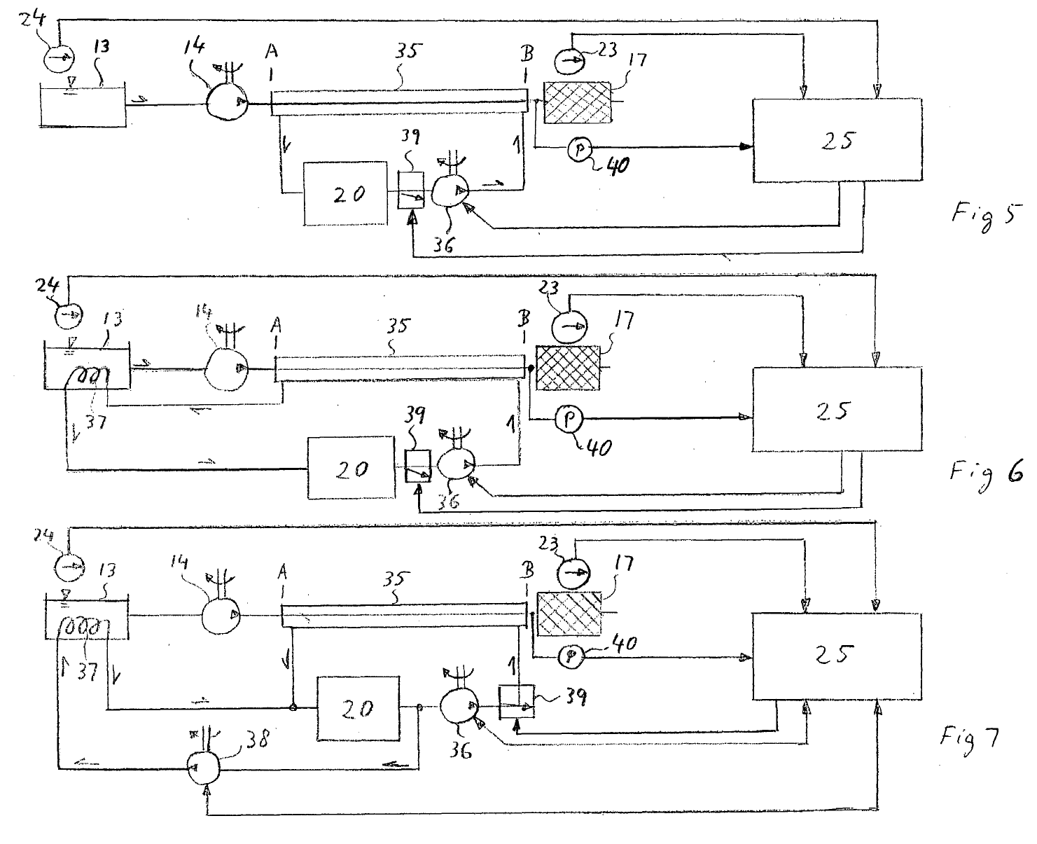

Between points A and B on FIGS. 1 and 4, the fuel pipe is optionally heated with cooling water, so that while using recycled vegetable oil in cold areas and all fats in the oil are melted. This prevents the solidification of vegetable oil at low ambient air temperatures. The fuel pipe is hereby connected to a hose, through which passes engine cooling water thereby realizing a counter flow heat exchanger. This hose heat exchanger 35 replaces the controller 15 and the heat exchanger 16. The cooling water is pumped through the heat exchanger by an electrically operated water pump 36 which is controlled by the microprocessor 25 as shown in FIG. 5. This microprocessor uses the data provided by the temperature sensors 23 and 24 to control the water pump 36. The hose heat exchanger 35 can be combined with a tank heating system 37 which consists of a heat pipe in the tank through which passes engine cooling water from the heat exchanger 35 as shown in FIG. 6. This prevents the solidification of vegetable oil at low ambient air temperatures.

Alternatively, there is the possibility of using separately an additional electric water pump 38 to supply the tank heating system 37 with engine cooling water. This allows separate tank temperature control independent from the heat exchanger temperature controlled by water pump 36 which will also be controlled by the microcontroller 25. This can be necessary under continuously cold ambient air temperature conditions when using a big vegetable oil tank as shown in FIG. 7.

The controller 15 provides a fairly constant fuel temperature in front of the filter 17. This is important in avoiding a too high vegetable oil temperature which can cause injection pump damage. It also prevents a too thin oil which can cause power loss in the diesel engine.

A manometer can be positioned in front of the vegetable oil filter 17 which shows excessive pressure in the fuel pipes. Increasing pressure indicates filter plugging. As an alternative a pressure sensor 40 can be installed. This sensor sends a signal to the microcontroller 25, which then shows the operator when a filter change is necessary. In addition, the microcontroller can compare the fuel pressure signal from sensor 40 with the filter temperature signal from sensor 23 and can decide if there is Diesel fuel or vegetable oil in the system, because of the different viscosity. If there is Diesel fuel in the vegetable oil fuel system, the microcontroller indicates a warning, reduces the heating temperature of the electric filter heater to 77° F. (25° C.) and switches off the heat exchanger 16 by an electric or pneumatic valve 39 in the coolant pipe in front of or behind the heat exchanger 16 shown in FIG. 1,3,4,5,6 and 7. This procedure prevents a possible fuel injection pump damage and allows to use the vegetable oil tank as a diesel tank for greater range when there is no vegetable oil available.

According to a second embodiment of the present invention, FIG. 4 shows a first circuit for diesel fuel consisting of the diesel tank 1, the diesel fuel pump 2, the mechanical fuel temperature controller 3 connected with the heat exchanger 4 supplied by engine cooling water, a fuel filter 5, a first pressure check valve 26, a diesel return pipe 27 and a second check valve 28, which is connected to a circuit 29. The circuit 29 comprises the feed pump 8, the fuel injection pump 9 and a 3/2-way solenoid valve 30. During cold start conditions of the engine, the diesel fuel is sucked by the fuel pump 2 from the diesel tank 1, passes the controller 3 and the filter 5 and then flows through the pressure check valve 26 to the circuit 29. The superfluous diesel which has not been consumed by the fuel injection pump 9 flows to the return pipe 27 into the diesel tank by pressure check valve 26.

There is a second fuel circuit consisting of the vegetable oil tank 13, the electric pump 14, the fuel temperature controller 15 connected with the heat exchanger 16 and an electrically heated fuel filter 17, a pressure check valve 31, a vegetable oil return pipe 32 and a second check valve 33.

Here, instead of solenoid valves, the running fuel pump determines what sort of fuel will reach circuit 29. Therefore, it is only allowed to run one single pump.

As soon as the combustion and injector temperatures of the diesel engine have reached a suitable level and the temperature of the vegetable oil is high enough, the diesel pump 2 stops running and at the same moment the vegetable oil fuel pump 14 starts running. The vegetable oil is sucked by fuel pump 14 from the vegetable oil tank 13, passes the controller 15 and the electrically heated fuel filter 17 (heating starts when diesel engine has been started) and flows through the pressure check valve 31 to the circuit 29. The superfluous vegetable oil which has not been consumed by the fuel injection pump 9 flows to return pipe 32 by pressure check valve 31.

Check valve 33 prevents diesel from contaminating the vegetable oil circuit and check valve 28 prevents vegetable oil contaminating the diesel circuit. When running with diesel and vegetable oil the 3/2-way solenoid valve 30 remains in the idle position. This way, the fuel will flow through the valve back to the feed and injection pump. In case of a long term engine shut off, the 3/2-way solenoid valve 30 switches and allows the vegetable oil to flow to pipe 34 which is connected with return pipe 32. At the same time the vegetable oil fuel pump 14 stops running and the diesel fuel pump 2 starts running and then the diesel pushes away the remaining vegetable oil out of the circuit 29 through pipe 34. Before diesel reaches pipe 34, the 3/2-way solenoid valve 30 switches back to circulation within circuit 29.

In case of repair and filter change the 3/2-way solenoid valve 30 switches to pipe 34 and the diesel or vegetable oil pump ventilates the system depending on what system had been affected by the intervention. The engine must not be started during the ventilation mode.

The whole system is controlled by the microprocessor 25 which uses the data provided by temperature sensors on engine 21, vegetable oil filter 23, vegetable oil tank 24 and a non-contact revolution sensor 22.

The system can also be equipped with 2 electric water pumps for a hose heat exchanger for vegetable oil heating and a tank heating system. Both fuel pumps 2 and 14 and both water pumps 36 and 38 are controlled by the microcontroller 25.

The microcontroller 25 is provided with a software which includes diagnostic routines. This allows to display system malfunctions for an easier problem finding and repair.

The description of the above embodiments are only used to illustrate the present invention, not intended to limit the scope thereof. Many modifications of the above embodiments can be made without departing from the spirit and scope of the invention.

What is claimed is:

1. Diesel engine with fuel system, operated with diesel and vegetable oil comprising two separate circuits for diesel and vegetable oil which runs with diesel during cold start phase and with vegetable oil when reaching the normal operating temperature, in which the vegetable oil is heated in a heat exchanger (15) fed with engine cooling water and under cold conditions the vegetable oil filter (17) is electrically preheated, and characterized in that the switching from diesel to vegetable oil and back is realized by two electrically activated 3/2-way solenoid valves (6) and (12) controlled by a microprocessor (25), which reads the signals of the engine temperature sensor (21), the tank temperature sensor (24), the vegetable oil filter temperature sensor (23) and the engine revolution sensor (22).

2. Diesel engine with fuel system according to claim 1, characterized in that the solenoid valve (6) is switched to vegetable oil supply as soon as it is determined that the required vegetable oil fuel temperature and engine temperature is reached.

3. Diesel engine with fuel system according to claim 1, characterized in that it has a vegetable oil pump (14) with a delivery rate which is higher than the highest consumption rate of the engine (20) under all operating conditions, so that the vegetable oil supply at the fuel injection pump (9) is always insured.

4. Diesel engine with fuel system according to claim 1, characterized in that it has a diesel fuel pump (3) with any possible delivery rate and which is only used to automatically ventilate the diesel circuit.

5. Diesel engine with fuel system according to claim 1, characterized in that prior to the engine shut down to solenoid valve (6) is switched to diesel and solenoid valve (12) switches to the return pipe (18) as long as all the vegetable oil is pushed out of circuit (11) by the incoming diesel fuel, provided by the fuel injection pump (9). This flush mode is determined by the engine revolutions and at the end of this period, the solenoid valve (12) switches back to circulation within circuit (11).

6. Diesel engine with fuel system, operated with diesel and vegetable oil comprising two separate circuits for diesel and vegetable oil which runs with diesel during cold start phase and with vegetable oil when reaching the normal operating temperature, in which the vegetable oil is heated in a heat exchanger being fed with engine cooling water and under cold conditions the vegetable oil filter is electrically preheated, characterized in that the switching from diesel to vegetable oil and back is realized by two fuel pumps (2) and (14) activating two hydraulic pressure check valves (26) and (31) which lead the superfluous fuel into the return pipes (27) and (32) of the corresponding fuel tanks (1) and (13), the two check valves (28) and (33) prevent the fuel from going into the wrong fuel circuit, all parts are controlled by a microprocessor (25) which reads the signals of the engine temperature sensor (21), the tank temperature sensor (24), the vegetable oil filter temperature sensor (23) and the engine revolution sensor (22).

7. Diesel engine with fuel system according to claim 6, characterized in that each of the two electrically driven fuel pumps (2) and (14) have a delivery rate higher than the consumption rate of the engine (20) under full load.

8. Diesel engine with fuel system according to claim 6, characterized in that only one fuel pump (either (2) or (14)) can be operated at a single time.

9. Diesel engine with fuel system according to claim 6, characterized in that previous to the engine shut down the fuel pump (14) switches off, the diesel feed pump (2) switches on at the same time and the solenoid valve (30) switches to return pipe (34), so that the diesel is pushed out of circuit (29). The duration of this flush mode is determined by the engine revolutions and after the end of this period, the solenoid valve (30) switches back to circulation within the circuit (29).

10. Diesel with fuel system according to any preceding claim, characterized in that the fuel circulates through the fuel injection pump (9) by circulating through the circuit (11) or (29). These circuits are initially filled with pure diesel under cold start conditions and after switching to vegetable oil the concentration of diesel will diminish slowly. This guarantees a smoother combustion change over to vegetable oil and allows the switching to vegetable oil at low engine temperatures.

11. Diesel engine with fuel system according to any preceding claim, characterized in that the system ventilates automatically after repair work, filter change or when a fuel tank is accidentally emptied.

12. Diesel engine with fuel system according to any preceding claim, characterized in that for diesel operation, vegetable oil flows through the preheated fuel filter (17), when the fuel pump (14) and the filter heating automatically start after engine (20) has been started.

13. Diesel engine with fuel system according to any preceding claim, characterized in that the controllers (3) and (15) ensure a constant fuel temperature under normal engine conditions.

14. Diesel engine with fuel system according to any preceding claim, characterized in that alternatively to the heat exchangers (4) and (16) and the controllers (3) and (15) a hose heat exchanger (35) is used, which uses engine cooling water and in which an electric water pump (36) controls the flow through the heat exchanger and thus the fuel temperature.

15. Diesel engine with fuel system according to any preceding claim, characterized in that the alternative hose heat exchanger can be combined with a tank heating system (37) where the electric water pump (36) controls the flow of engine cooling water through the hose heat exchanger (35) and the tank heating system (37) and thus the tank and fuel temperature.

16. Diesel engine with fuel system according to any preceding claim, characterized in that the tank heating system (37) can be alternatively fed with engine cooling water by an additional water pump (38) which only controls the flow through the tank heating system (37) and thus the tank temperature independent of the heat exchanger temperature.

17. Diesel engine with fuel system according to any preceding claim, characterized in that alternatively, a manometer can be connected to the fuel pipe before the vegetable oil filter to indicate the fuel pressure to get information of the filter condition. This manometer can be amended or replaced by a pressure sensor (40) which sends a signal to the microcontroller (25) to indicate that a filter change is required.

18. Diesel engine with fuel system according to any preceding claim, characterized in that alternatively, a pressure sensor (40) can be connected to the fuel pipe directly in front of the vegetable oil filter for fuel viscosity control

19. Diesel engine with fuel system according to any preceding claim, characterized in that the software of the microcontroller (25) includes diagnostic routines and displays system malfunctions which allows a quick problem solving on the system.

20. Vehicle with a diesel engine with a fuel system according to any preceding claim.
